(19) United States
(12) Patent Application Publication
(10) Pub. No.: US 2013/0320629 A1
(43) Pub. Date: Dec. 5, 2013

(54) Radial Shaft Seal Ring

(71) Applicants: Helmut Benedix, Leichlingen-Witzfeld (DE); Juergen Netzer, Burscheid (DE); Willy Seewald, Remscheid (DE)

(72) Inventors: Helmut Benedix, Leichlingen-Witzfeld (DE); Juergen Netzer, Burscheid (DE); Willy Seewald, Remscheid (DE)

(21) Appl. No.: 13/988,591

(22) PCT Filed: Nov. 21, 2011
(86) PCT No.: PCT/EP11/70549

§ 371 Date: Aug. 9, 2013

(30) Foreign Application Priority Data
Nov. 24, 2010 (DE) 10 2010 061 819.5

(51) Int. Cl. F16J 15/32

(52) U.S. Cl. CPC F16J 15/32
USPC 277/549

(57) ABSTRACT

A radial shaft seal ring includes a reinforcing ring and an elastomer part connected to the reinforcing ring. The elastomer part includes a dynamic sealing lip having a radial sealing lip section and an axial sealing lip section. The axial sealing lip section includes a sealing edge for sealing abutment on a shaft. The sealing edge is disposed on an inner peripheral wall of the axial sealing lip section and the inner peripheral wall faces towards the shaft. The axial sealing lip section further includes a reinforcing structure.

The invention relates to a radial shaft seal ring having a reinforcing ring and an elastomer part connected to the reinforcing ring, which elastomer part has a dynamic sealing lip with a radial sealing lip section and an axial sealing lip section, wherein the axial sealing lip section has a sealing edge for a sealing abutment on a shaft, which sealing edge is disposed on an inner peripheral wall of the axial sealing lip section, which inner peripheral wall faces towards the shaft.

DE 25 56 992 C2 describes a shaft seal ring having a sealing lip made of elastic material, whose air-side contact surface, which extends inclined towards the shaft surface, has a plurality of rib pairs distributed around the circumference, whose individual ribs alternatingly extend in opposing circumferential directions and meet in the sealing edge in a point, wherein inside each first rib pair a further rib pair is provided, whose individual ribs meet in respectively opposing directions inclined towards the corresponding ribs of the first rib pair and end there.

It is an object of the invention to provide a radial shaft seal ring having an improved sealing effect under a reduced pressure load.

The object of the invention is achieved by a radial shaft sealing ring having a reinforcing ring and an elastomer part connected to the reinforcing ring, which elastomer part has a dynamic sealing lip with a radial sealing lip section and an axial sealing lip section, wherein the axial sealing lip section has a sealing surface for a sealing abutment on a shaft, which sealing surface is disposed on an inner peripheral wall of the axial sealing lip section, which inner peripheral wall faces towards the shaft, wherein the axial sealing lip section has a reinforcing structure.

The reinforcing structure can be formed by a particular design of the dynamic sealing lip, in particular of the axial sealing lip section. Alternatively the reinforcing structure can be formed by a separate component which is connected to the axial sealing lip section.

The reinforcing structure is formed to hold the axial sealing lip section, in particular a free axial end of the axial sealing lip section, in contact with the surface of a shaft to be sealed, or at least reduce a reduced-pressure-induced lifting of the free axial end of the axial sealing lip section from the surface of the shaft.

For example, to seal a passage of a shaft through a housing wall of a machine, a radial shaft seal ring can be provided in the wall of the housing whose dynamic sealing lip slides in a sealing manner over an outer circumference of the shaft. A sealing using a sealing lip of the radial shaft seal ring can in particular serve to prevent oil, which is located in the machine housing, from leaking from the housing through a gap between housing wall and shaft. Machines, for example internal-combustion engines, wherein a reduced pressure develops in the crankcase, should be sealed using radial shaft seal rings in such a way that leakage of oil from the housing is prevented. Here, as also in other cases, the radial shaft seal rings are installed with their free axial ends of the axial sealing lip section with the dynamic sealing edge oriented towards the oil chamber. In particular with elastomer sealing lips, a lifting of the free axial end of the axial sealing lip section can occur due to the reduced pressure prevailing in the housing. Using the inventive reinforcing structure, a lifting of the free axial end of an axial sealing lip section is reduced and/or suppressed or completely prevented.

The reinforcing structure can be disposed on one of the outer peripheral walls of the axial sealing lip section, which outer peripheral wall is opposite the inner peripheral wall of the axial sealing lip section. The reinforcing structure stabilizes the basic shape of the axial sealing lip section and reduces or prevents a bulging, in particular tulip-like bulging, of the free axial end of the axial sealing lip section or the ring edge on the free axial end of the axial sealing lip section.

The reinforcing structure can be formed from a plurality of, in particular at least six, for example also eight support strips, which extend in the axial direction or at least substantially in the axial direction. The support strips form ribs, which can protrude radially outward from the outer peripheral wall of the axial sealing lip section. In this respect the ribs can increase the flexural stiffness in the axial direction and the stiffness of the axial sealing lip section against bulging. The support strips can be formed one-piece on the axial sealing lip section or manufactured one-piece therewith, for example in a forming tool.

The plurality of, in particular at least six, for example also eight support strips can extend at equal intervals around the circumference of the outer peripheral wall of the axial sealing lip section. The support strips can thus extend parallel to the axial extension of the axial sealing lip section. The support strips can optionally also be oriented by a radial amount different from the parallel extension.

In all inventive embodiments with support strips, the plurality of, in particular at least six, for example also eight support strips can extend in the radial direction completely or at least over a partial length along the radial sealing lip section. The support strips can thus extend along the axial sealing lip section and continue on the radial sealing lip section. Because the support strips continue on the radial sealing lip section, stiffness can be increased in the transition region from the axial sealing lip section to the radial sealing lip section.

In all inventive embodiments with support strips, the plurality of, in particular at least six, for example also eight support strips can connect the axial sealing lip section to the radial sealing lip section. Because the support strips connect the axial sealing lip section to the radial sealing lip section, stiffness can be increased in the transition region from the axial sealing lip section to the radial sealing lip section.

The plurality of, in particular at least six, for example also eight support strips can have edges oriented radially outwards, whose curvature has a lesser curvature, at least over a partial length of the edge, than a connecting section between the axial sealing lip section and the radial sealing lip section of the sealing lip. In this respect the support strips connect the axial sealing lip section and the radial sealing lip section in the manner of fin-shaped projections.

In an alternative or additional embodiment of the support strips, the reinforcing structure can be formed from at least one ring, which has a rigid ring section encircling the circumference of the axial sealing lip section. In this respect the ring is manufactured as a separate component and connected to the axial sealing lip section.

The ring can have a radially extending rigid ring section and an axially extending, in particular slotted and/or open-at-the-edge, ring section.

In all inventive embodiments the ring can have a substantially axially extending ring section, which tapers conically towards the free end of the axial sealing lip section. The conical tapering can be designed such that in the uninstalled state of the radial shaft seal ring, i.e. in an undeformed state of the dynamic sealing lip, the sealing edge forms an inner diameter which is slightly smaller than the outer diameter of the shaft to be sealed.

In all inventive embodiments the ring can be a metal ring, in particular a spring steel ring.

In all described embodiments the axial sealing lip section can have a sealing edge made from an elastomer material.

In an alternative design of the invention the axial sealing lip section can have a sealing edge made from polytetrafluoroethylene (PTFE).

In a specific further development of the sealing edge made from polytetrafluoroethylene (PTFE), the sealing edge can be formed on an inner peripheral wall of a housing or of a hollow cylindrical ring made from polytetrafluoroethylene (PTFE). In this case, the sleeve or the ring can be connected with the axial sealing lip section of the elastomer part. In particular, the sleeve or the ring can be vulcanized onto the axial sealing lip section of the elastomer part.

In summary, the invention can thus provide a solution in particular for reduced-friction radial shaft seal rings made from elastomer materials.

Reduced-friction radial shaft seals made from elastomer materials are formed with, among other things, a spiral-shaped oil return feed apparatus and optionally additionally with a static dam for gas-tightness while stationary.

Radial shaft seal rings made from elastomer materials are generally very flexible. At increased underpressure, radial shaft seal rings made from elastomer materials can briefly lose contact with the shaft to be sealed, so that leaks or noise can result due to fluttering.

Furthermore, a reduced pressure resistance over the service life of the radial shaft seal ring can fall due a setting behavior of the elastomer material caused by temperature and time, i.e. aging. This can lead to a reduction in the durability of the radial shaft seal ring.

According to the invention, the sealing lip of the radial shaft seal ring made of elastomer material can have a plurality of, in particular at least six, for example eight in particular thin support strips, which connect or strengthen a radial and an axial region of the radial shaft seal ring. These support strips can be manufactured from the same material as the sealing lip itself and in particular can be integrally manufactured in the same tool for the radial shaft seal ring.

Alternatively or additionally, in such an embodiment of the radial shaft end seal, a spring ring or a metal part can be integrated, which can provide pressure stability, in particular further pressure stability. A potential exists with an inventive reinforced sealing lip to further optimize the friction of the seal.

A decoupling of the dynamic seal lip from internal pressure can be achieved.

An optimization of the coefficient of friction can result from a tailored elastomer contour. The service life of the radial shaft seal ring can thereby be extended.

Various exemplary embodiments of the invention are depicted in an exemplarily manner in the accompanying schematic drawings:

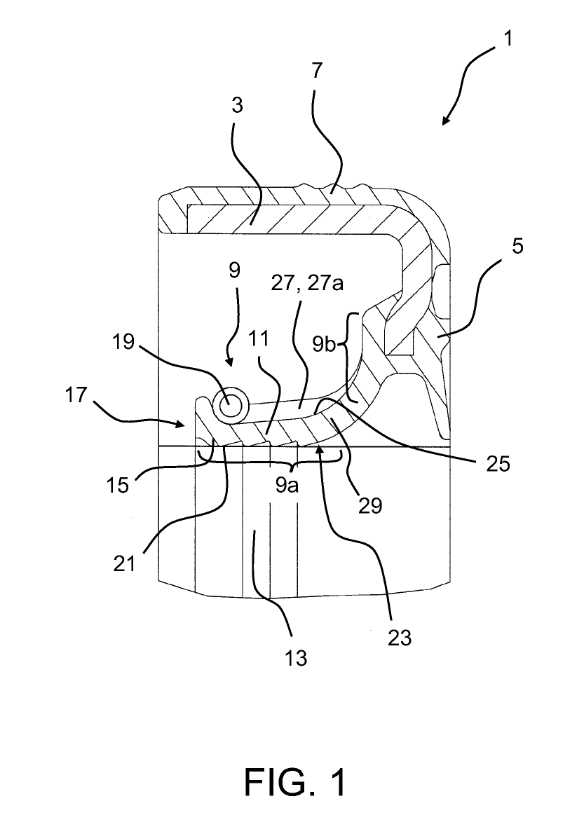

FIG. 1 shows a longitudinal section through an upper half of a radial shaft seal ring having a first embodiment of an inventive reinforcing structure in the design as support strips;

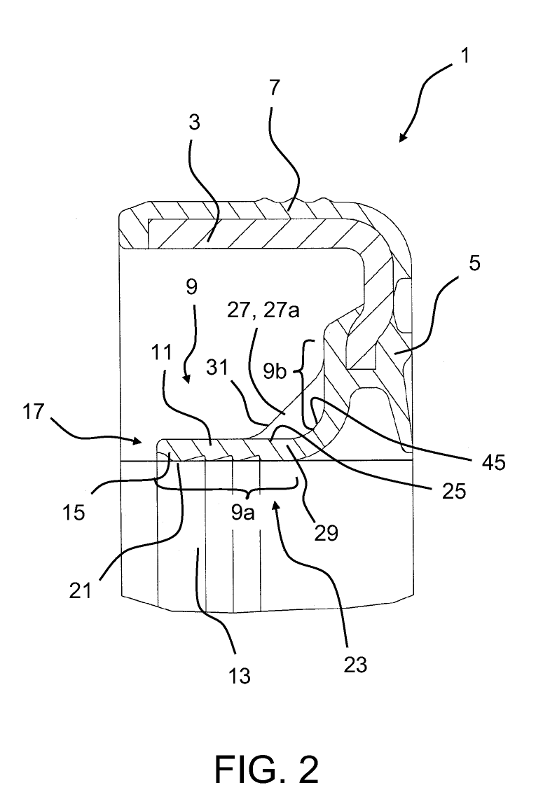

FIG. 2 shows a longitudinal section through an upper half of a radial shaft seal ring having a second embodiment of an inventive reinforcing structure in the design as support strips;

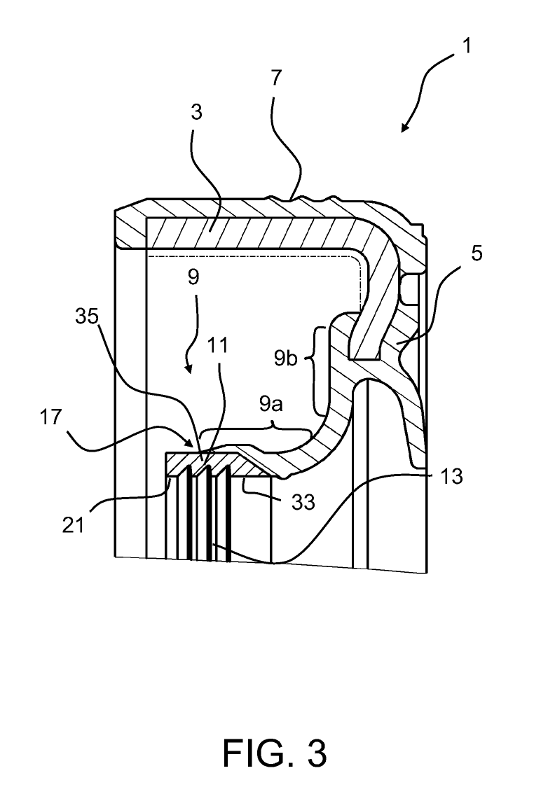

FIG. 3 shows a longitudinal section through an upper half of a radial shaft seal ring having a third embodiment of an inventive reinforcing structure as an overlapping-formed part;

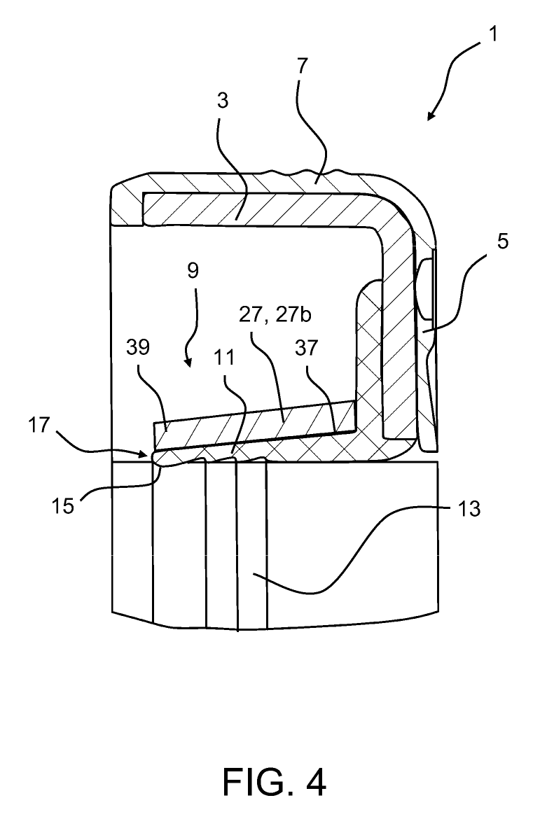

FIG. 4 shows a longitudinal section through an upper half of a radial shaft seal ring having a fourth embodiment of an inventive reinforcing structure as a metal ring;

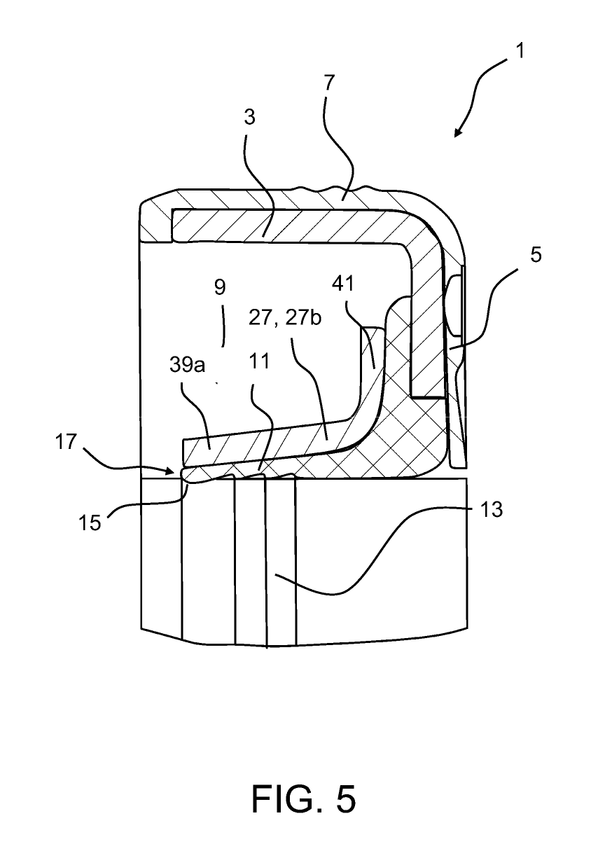

FIG. 5 shows a longitudinal section through an upper half of a radial shaft seal ring having a fifth embodiment of an inventive reinforcing structure as a metal ring including a radially extending rigid ring section;

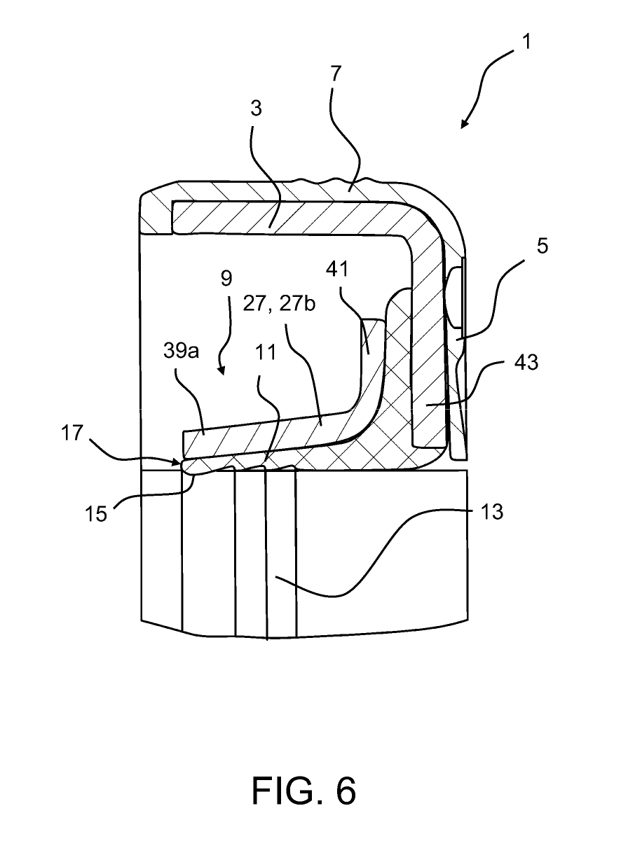

FIG. 6 shows a longitudinal section through an upper half of a radial shaft seal ring having a sixth embodiment of an inventive reinforcing structure as a slotted metal ring.

FIG. 1 shows a longitudinal section through an upper half of a radial shaft seal ring 1 as a first exemplary embodiment of the invention. Here the radial shaft seal ring 1 has a reinforcing ring 3 as well as an elastomer part 5 connected to the reinforcement ring 3 and formed in one-piece. Here the reinforcing ring 3 is manufactured from a metal plate. The elastomer part 5 is connected to the reinforcing ring 3 by vulcanization thereto.

The elastomer part 5 has a static sealing region 7, whose outer surface abuts for the static seal on a not-shown housing part in the region of a passage opening, for example of a housing for an also not-shown shaft to be sealed.

The elastomer part 5 has a dynamic sealing lip 9, which abuts on the not-shown shaft upon installation of the radial shaft seal ring 1 as intended. The sealing lip 9 has a first seal section 11. This first seal section 11 is provided with a threadlike return feed structure 13. The threadlike return feed structure 13 is shown greatly exaggerated in FIG. 1, in order to make the threadlike passages of the return feed structure 13 and their transition or discharge path into a second seal section 15 clearly visible. Instead of the three revolutions of passages shown, the return feed structure 13 can also have more than three passages. The rise of the passages is actually distinctly much smaller than shown. The rise of the passages can for example be 0.7 or 0.75 mm.

The sealing lip 9 carries the second seal section 15 at a free end 17. The second seal section 15 can be equipped with a known spring 19 for pretensioning of the second seal section 15.

As shown in the exemplary embodiment of FIG. 1, the dynamic seal lip 9 has an axial seal lip section 9a and a radial seal lip section 9b. The axial seal lip section 9a has a return feed structure 13 for a sealing abutment on a shaft, which return feed structure 13 is disposed on an inner peripheral wall 23 of the axial sealing lip section 9a, which inner peripheral wall 13 faces towards the shaft. The axial sealing lip section 9a has a reinforcing structure 27 on an outer peripheral wall 25 opposite the inner peripheral wall 23. In the embodiment according to FIG. 1, the reinforcing structure 27 is formed from a plurality of, in particular at least six support strips 27a, which extend in the axial direction or at least substantially in the axial direction.

The axial direction refers here to the axial extension of the shaft or of the shaft axis. This also means that the axial direction means the axial extension of the hollow cylindrical axial sealing lip section 9a. This axial extension corresponds here to the rotational axis of the hollow cylindrical basic shape of the axial sealing lip section 9a. The references to the inner peripheral wall 23 and the outer peripheral wall 25 also arise based on the hollow cylindrical basic shape of the axial sealing lip section 9a. The plurality of, in particular at least six, support strips 27a are attached to the outer peripheral wall 25 of the axial sealing lip section 9a and rise radially outward from this outer peripheral wall.

The plurality of, in particular at least six, support strips 27a extend radially outwards at equal intervals around the circumference of the outer peripheral wall of the axial sealing lip section.

In the embodiment according to FIG. 1, the support strips 27a slightly extend over and onto the radial sealing lip section 9b in a curved transition section 29 of the sealing lip 9 between axial sealing lip section 9a and radial sealing lip section 9b. In this case the height of the support strips 27a can gradually reduce to zero in the region of the reinforcing ring 3.

The embodiment according to FIG. 1 can be formed as shown with a spring 19 or without a spring 19 for pretensioning of the second seal section 15.

In the embodiment according to FIG. 2, the plurality of, in particular at least six, support strips 27a extend almost completely in the radial direction, i.e. at least over a partial length along the radial sealing lip section 9b. In this case the support strips 27a have a triangular basic shape in the lateral plan view. In the embodiment according to FIG. 2, the support strips 27a thereby form triangle-shaped reinforcing ribs. In the embodiment according to FIG. 2, the support strips 27a each have a free edge 31, which extend in an angle of approximately 45 degrees to the axial sealing lip section 9a and the radial sealing lip section 9b. In the embodiment according to FIG. 2, the plurality of, in particular at least six, support strips 27a connect in this respect the axial sealing lip section 9a to the radial sealing lip section 9b.

Compared to the embodiment according to FIG. 1, in the embodiment according to FIG. 2 the plurality of, in particular at least six, support strips 27a have edges 31 oriented radially outward, whose curvature has a lesser curvature, at least over a partial length of the edge 31, than a connecting section 45 between the axial sealing lip section 9a and the radial sealing lip section 9b of the sealing lip 9.

The embodiment according to FIG. 2 can be formed with a spring 19 or, as shown, without a spring 19 for pretensioning of the second seal section 15.

In an embodiment according to FIG. 3, the axial sealing lip section 9a is manufactured from an elastomer and shortened in its axial direction as compared to the embodiments of FIGS. 1 and 2. A sealing surface 21 made of polytetrafluoroethylene (PTFE) is attached to the free end 17 of the axial elastomeric sealing lip section 9a. The sealing surface 21 made of polytetrafluoroethylene (PTFE) is thereby formed as the inner peripheral wall 33 of a sleeve 35, i.e. a hollow cylindrical ring made of polytetrafluoroethylene (PTFE). The sleeve 35 is connected to the axial elastomeric sealing lip section 9a of the elastomer part 9 by vulcanization.

In an embodiment according to FIG. 4, the reinforcing structure 27 is formed from at least one ring 27b, which has a rigid ring section 39 encircling the circumference 37 of the axial sealing lip section 9a. In the embodiment according to FIG. 4, the ring section 39, which extends substantially axially, tapers conically towards the free end 17 of the axial sealing lip section 9a.

In an embodiment according to FIG. 5, the reinforcing structure 27 is formed from at least one ring 27b, which has a radially extending, rigid ring section 41 and an axially extending, slotted, in particular open-at-the-edge, slotted ring section 39a. In the embodiment according to FIG. 5, the ring section 39a which extends substantially axially tapers conically towards the free end 17 of the axial sealing lip section 9a.

In an embodiment according to FIG. 6, the reinforcing structure 27 is formed from at least one ring 27b, which has a radially extending, rigid ring section 41 and an axially extending, slotted, in particular open-at-the-edge, slotted ring section 39a. In the embodiment according to FIG. 5, the ring section 39a which extends substantially axially tapers conically towards the free end 17 of the axial sealing lip section 9a. Compared to the embodiment according to FIG. 5, the radial shaft seal ring 1 according to FIG. 6 has a reinforcing ring 3 with an extended radial ring section 43.

### Reference Number List

1 Radial shaft seal ring
3 Reinforcing ring
5 Elastomer part
7 Static sealing region
9 Sealing lip
9a Axial sealing lip section
9b Radial sealing lip section
11 First seal section
13 Return feed structure
15 Second seal section
17 Free end
19 Spring
21 Sealing edge
23 Inner peripheral wall
25 Outer peripheral wall
27 Reinforcing structure
27a Support strips
27b Ring
29 Transition section
31 Free edge
33 Peripheral wall
35 Sleeve
37 Circumference
39 Ring section
39a Slotted ring section
41 Rigid ring section
43 Radial ring section
45 Connection section

1.-10. (canceled)

11. A radial shaft seal comprising:
a reinforcing ring,
an elastomer part connected to the reinforcing ring, the elastomer part including a dynamic sealing lip having a radial sealing lip section and an axial sealing lip section, and
a reinforcing structure integrally formed at least on the axial sealing lip section, the reinforcing structure having a plurality of support strips that extend in an axial direction of the radial shaft seal or at least substantially in the axial direction of the radial shaft seal,
wherein the axial sealing lip section includes a sealing surface configured to sealingly abut on a shaft, the sealing surface being disposed on an inner peripheral wall of the axial sealing lip section that faces towards the shaft.

12. The radial shaft seal according to claim 11, wherein the reinforcing structure is disposed on a radially-outer peripheral wall of the axial sealing lip section that is disposed opposite of the inner peripheral wall of the axial sealing lip section.

13. The radial shaft seal according to claim 12, wherein the reinforcing structure includes at least six of the support strips.

14. The radial shaft seal according to claim 13, wherein the support strips extend at equal intervals around the circumference of the outer peripheral surface of the axial sealing lip section.

15. The radial shaft seal according to claim 14, wherein the support strips also extend at least partially over the radial sealing lip section.

16. The radial shaft seal according to claim 15, wherein each support strip includes a radially-outward-extending edge having a curvature that is less, at least over a partial length of the edge, than the curvature of a connecting section of the dynamic sealing lip disposed between the axial sealing lip section and the radial sealing lip section.

17. The radial shaft seal according to claim 11, wherein the reinforcing structure includes at least one ring having a rigid annular section encircling the circumference of the axial sealing lip section.

18. The radial shaft seal according to claim 17, wherein the at least one ring further includes an at least substantially axially-extending annular section connected to the rigid annular section, which extends at least substantially radially.

19. The radial shaft seal according to claim 17, wherein the at least one ring is comprised of spring steel.

20. The radial shaft seal according to claim 19, wherein at least substantially axially-extending annular section has a slotted and/or open-at-the-edge shape.

21. The radial shaft seal according to claim 18, wherein the at least substantially axially-extending annular section tapers conically towards a free end of the axial sealing lip section.

22. The radial shaft seal according to claim 11, wherein the axial sealing lip section has a sealing edge made from an elastomer material and/or polytetrafluoroethylene (PTFE).

23. The radial shaft seal according to claim 22, wherein the sealing edge is disposed on an inner peripheral wall of a sleeve made of polytetrafluoroethylene (PTFE), the sleeve being connected to a terminal end of the axial sealing lip section of the elastomer part.

24. The radial shaft seal according to claim 11, wherein the reinforcing structure includes at least six of the support strips.

25. The radial shaft seal according to claim 24, wherein the support strips extend in parallel at equal intervals around the circumference of the outer peripheral surface of the axial sealing lip section.

26. The radial shaft seal according to claim 24, wherein the support strips also extend at least partially over the radial sealing lip section.

27. The radial shaft seal according to claim 26, wherein each support strip includes a radially-outward-extending edge having a curvature that is less, at least over a partial length of the edge, than the curvature of a connecting section of the dynamic sealing lip disposed between the axial sealing lip section and the radial sealing lip section.
